(19) United States
(12) Patent Application Publication
(10) Pub. No.: US 2012/0281546 A1
(43) Pub. Date: Nov. 8, 2012

(54) Device and Method for Locating Voice Transmission Problems

(75) Inventors: Pinghua Li, Shenzhen (CN); Donghua Lu, Shenzhen (CN); Jiangang Zhang, Shenzhen (CN); Baiqiu Huang, Shenzhen (CN)

(73) Assignee: ZTE CORPORATION, Shenzhen City, Guangdong Province (CN)

(21) Appl. No.: 13/257,762

(22) PCT Filed: Nov. 26, 2010
(86) PCT No.: PCT/CN10/79189

§ 371 Date: Nov. 25, 2011

(30) Foreign Application Priority Data
Feb. 1, 2010 (CN) 201019164018.4

(51) Int. Cl. H04W 24/00

(52) U.S. Cl. 370/242

(57) ABSTRACT

A method and device for locating voice transmission problems are provided. The method includes: configuring a data transmitting/receiving statistics module at each transmission stage of a media stream to perform statistics on data transmitting/receiving of the transmission stage; the data transmitting/receiving statistics module reporting data after statistics to a preset data analysis module; and the data analysis module locating the voice transmission problems after analyzing the data reported by the data transmitting/receiving statistics module. The device includes the data transmitting/receiving statistics module and the data analysis module. The method and device can automatically detect the voice transmission problems such as getting through in one-way, discontinuous, etc., and discover the voice transmission problems existing in the system in time, thereby quickly locating the transmission stage of the media stream at which the voice transmission problems appear, enhancing the location efficiency of the voice transmission problems, and shortening the fault location period.

### TECHNICAL FIELD

The invention relates to the field of communications, in particular, to a device and method for locating voice transmission problems.

### BACKGROUND OF THE RELATED ART

CDMA2000, as a mainstream technology in the future, has been widely accepted in the industry. Along with the CDMA2000 network technology increasingly mature, all the global telecommunication operators begin to deploy the CDMA2000 network in a great quantity. The present CDMA2000 network is a complicated network with a soft handoff being a core, in which various types of interfaces, protocols and media coexist. After the CDMA2000 network is used in the increasing large scale, more troublesome issues, such as network instability, poor user voice quality, and the greatly increased number of complaints, will be inevitably encountered due to the complexity of the CDMA2000 technology. The most common representation form is voice transmission problems, such as getting through in one-way (i.e., one party can hear the voice of the opposite party but the opposite party cannot hear the voice of the one party, and vice versa), discontinuous (i.e., the voice of the opposite party which is heard by the one party is off and on, and vice versa) and not getting through in two-way, etc. For these problems, it often takes a lot of manpower and material resources to re-present and solve these problems.

A packet-based CDMA2000 base station subsystem (BSS) can access into a soft handoff based CDMA2000 core network by way of using a transmission mode of time division multiplexing (TDM), and can also access into the soft handoff based CDMA2000 core network by way of using an internet protocol (IP) switch technology. In the process of CDMA system service channel transmitting, every one frame time (where one frame time is typically 20 ms), a base transceiver station (BTS) transmits one traffic frame to a mobile station (MS) and the MS transmits one reverse traffic frame to the BTS. When implementing the voice service in the transmission mode of TDM, a CDMA access network needs to transmit a voice frame transmitted from an air interface to a base station controller (BSC) through the BTS, the voice frame is converted into a pulse coded modulation (PCM) code flow by a vocoder, and then the PCM code flow is transmitted to the core network through a TDM circuit. When adopting the transmission mode of the IP switch technology, the voice frame is transmitted from the BTS to the BSC after the CDMA access network receives the voice frame from the air interface, and then the voice frame is directly encapsulated into a real-time transport protocol (RTP) packet to be transmitted by an IP network, without the codec conversion. In the whole process, as shown in FIG. 1, from the BTS receiving the frame from the air interface, to the BTS transmitting the frame to the core network, and then to transmitting the frame to the target BSC and the target BTS, the transmission stages are various. A problem present in any stage of the transmission process may cause a problem in the voice transmission. It is important for fault locating that how to quickly locate at the transmission stage having the problems after the voice transmission problems happen.

### CONTENT OF THE INVENTION

For the above described problem, the present invention is intended to provide a device and method for locating voice transmission problems, so as to locate the problems of transmission stages of media stream in time.

According to one aspect of the present invention, a device for locating voice transmission problems is provided, comprising:

a data transmitting/receiving statistics module, configured to report data to a data analysis module after performing statistics on data transmitting/receiving of a transmission stage of a media stream, and

the data analysis module, configured to locate the voice transmission problems after analyzing the data reported by the data transmitting/receiving statistics module.

The data analysis module comprises:

a master control module, configured to inform the data transmitting/receiving statistics module to perform or stop the statistics on the data transmitting/receiving and to start or stop reporting;

a data collection module, configured to collect and save the data reported by each data transmitting/receiving statistics modules, and forward the data to the data analysis module after the data reported by all the data transmitting/receiving statistics modules have been gathered together or after a certain period of time; and

a display module, configured to display a analysis result of the data analysis module.

The certain period of time is preset according to a condition of each transmission stage of the media stream.

The data transmitting/receiving statistics module(s) is located at one or more media plane processing nodes.

The media plane processing nodes comprise a channel processing module at a base station transceiver side, a selected distribute multiplex demultiplex module at a base station controller side, an interface board and a voice transcoder board.

The data transmitting/receiving statistics module is further configured to perform statistics on types of received frames.

The device further comprises a plurality of data analysis modules, which are located on the same board or resided in different boards.

The data analysis module is configured to locate the voice transmission problems according to following steps: locating the voice transmission problems by comparing statistics values of the data transmitting/receiving of each transmission stage of the media stream.

According to another aspect of the present invention, a method for locating voice transmission problems is provided, comprising:

configuring a data transmitting/receiving statistics module at each transmission stage of a media stream to perform statistics on data transmitting/receiving of the transmission stage;

the data transmitting/receiving statistics module reporting data after statistics to a preset data analysis module; and

the data analysis module locating the voice transmission problems after analyzing the data reported by the data transmitting/receiving statistics module.

The step of the data transmitting/receiving statistics module performing the statistics on the data transmitting/receiving of each processing stage of the media stream further comprises: performing statistics on the number of transmitted and received frames.

The step of the data analysis module locating the voice transmission problems comprises: the data analysis module deriving a difference between the number of the received frames and the number of the transmitted frames of two transmission stages of the media stream which are adjacent or nonadjacent, and judging whether the difference is within a predetermined range; and if the difference is within the predetermined range, a voice transmission is normal, and if the difference is beyond the predetermined range, there is a problem in the voice transmission.

The present method can automatically detect the voice transmission problems such as getting through in one-way, discontinuous, etc. in the system, and discover the voice transmission problems existing in the system in time, thereby quickly locating the transmission stage of the media stream at which the voice transmission problems appear, enhancing the location efficiency of the voice transmission problems, and shortening the fault location period.

### BRIEF DESCRIPTION OF DRAWINGS

The accompanying drawings described herein are used to provide further understanding for the present invention and constitute a part of the present application. The illustrated embodiments of the present invention and the description thereof are used to explain the present invention, rather than constituting an inappropriate limitation to the present invention. Wherein:

FIG. 1 illustrates a schematic diagram of a transmission of a media stream in a CDMA2000 system;

FIG. 2 illustrates a structural diagram of a device for locating voice transmission problems in accordance with an embodiment of the present invention; and

FIG. 3 illustrates a flowchart of a method for locating voice transmission problems in accordance with an embodiment of the present invention.

### PREFERRED EMBODIMENTS OF THE PRESENT INVENTION

The present invention is described in detail with reference to the accompanying drawings and in combination with embodiments hereinafter. It should be illustrated that, in the case of not conflicting, the embodiments in the present application and features in these embodiments can be combined with each other.

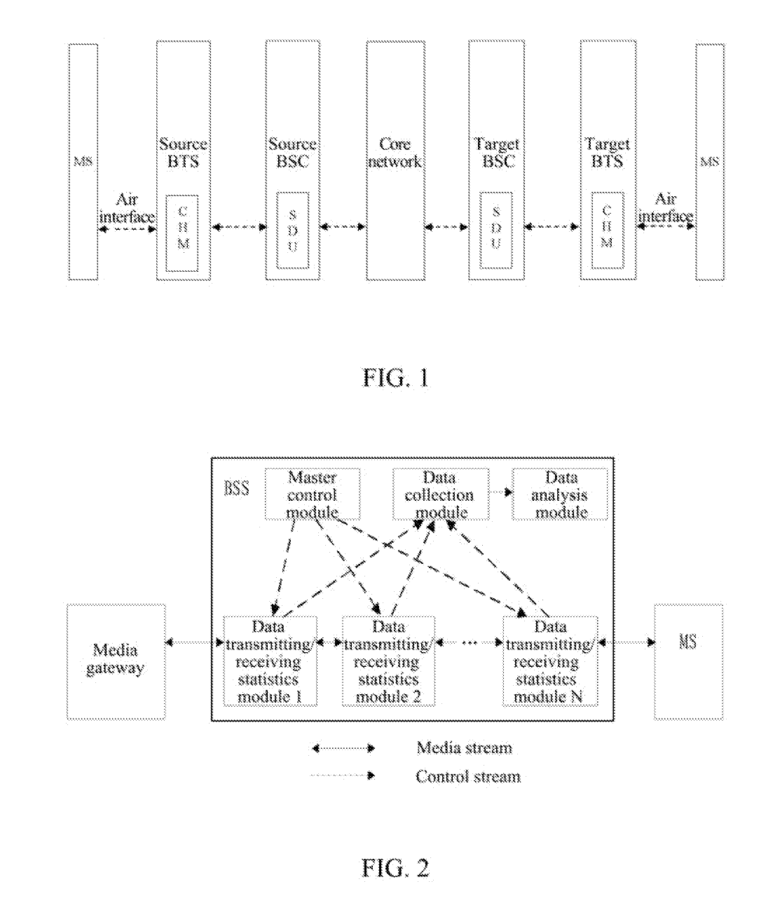

Taking CDMA2000 legacy mobile station domain (LMSD) as an example, the transmission of the media stream in the CDMA2000 system is shown as FIG. 1. A device and method for locating voice transmission problems are provided in the present invention can automatically detect the voice transmission problems such as getting through in one-way, discontinuous, etc. in the system, and discover the voice transmission problems existing in the system in time, thereby quickly locating the transmission stage of the media stream at which the voice transmission problems appear, enhancing the location efficiency of the voice transmission problems, and shortening the fault location period.

FIG. 2 illustrates a structural diagram of a device for locating voice transmission problems in accordance with an example of the present invention.

A data transmitting/receiving statistics module in the device is configured to report data to a data analysis module after performing statistics on data transmitting/receiving of transmission stages of a media stream; and the data analysis module is configured to locate voice transmission problems after analyzing the data reported by the data transmitting/receiving statistics module. Wherein, a master control module, a data collection module and the data analysis module can be the same module or can also be different modules, and can be located on the same board or can also be resided respectively in different boards.

The master control module is configured to determine when to start, query and stop the data transmitting/receiving statistics; each data transmitting/receiving statistics module is configured to be resided in each transmission stage of the media stream and be responsible for fulfilling the statistics on the data transmitting/receiving of each transmission stage of the media stream; the data collection module is configured to be responsible for collecting the data reported by the data transmitting/receiving statistics modules; the data analysis module is configured to be responsible for analyzing the received statistic data and determining the transmission stage of the media stream at which the voice transmission problems appear. The specific architecture is shown as FIG. 2.

The master control module initiates monitoring/locating for getting through in one-way and discontinuous, and informs the data transmitting/receiving statistics module resided in each transmission stage of the media stream to start the data transmitting/receiving statistics. The master control module can be located at the BSC side, and can also be located at the MSC side; wherein, for the BSC side, the master control module can be located at a call control module of the BSC and can also be located at an operate & maintain centre (OMC) back stage, etc.

The data transmitting/receiving statistics module performs statistics on the data transmitting/receiving of the transmission stage of the media stream in which the corresponding data transmitting/receiving statistics module is resided. The data transmitting/receiving statistics module can be located at any stage of media plane processing, i.e., the data transmitting/receiving statistics module can be located at one or more media plane processing nodes; wherein, the media plane processing nodes include a media plane processing board or module, such as channel module (CHM) at the BTS side, the selected distribute multiplex demultiplex module (SDM) at the BSC side, each interface board (such as, DSM, ABPM, IPI, etc.) and VTC board, etc. The operations performed by the data transmitting/receiving statistics module include but are not limited to perform the statistics on the data transmitting/receiving of each processing stage of the media stream, can further include performing statistics on the types of the received frames and other information, and so on.

The master control module informs each data transmitting/receiving statistics module to report the data to the data collection module.

The data transmitting/receiving statistics module reports the data of the data transmitting/receiving statistics to the data collection module.

The data collection module saves the data reported by each data transmitting/receiving statistics module and collects them, and forwards the data to the data analysis module after the data reported by all the data transmitting/receiving statistics modules have been gathered together or after a certain period of time; wherein, the period of time can be implemented by initiating a timer, and the specific time can be set manually according to the condition of each transmission stage of the media stream.

The data analysis module analyzes all the data of one call to determine the transmission stage of the media stream at which the problems appear. The method for analyzing all the data of one call described herein includes but is not limited to implementing the analysis by comparing statistic values of the data transmitting/receiving of each stage. Specifically, the data analysis module compares the number of the received frames and the number of the transmitted frames of two transmission stages of the media stream which are adjacent, and judges whether a difference between them is within a reasonable range; and if the difference is within the reasonable range, the voice transmission is normal, and if the difference is beyond the reasonable range, there is a problem in the voice transmission. There are a plurality of methods to determine whether the difference is within the reasonable range, for example, the data analysis module derives the difference of each stage, accumulates the differences to obtain the total difference, and compares the total difference with the number of the frames which should be received or transmitted (which can be calculated by the time, that is, the CDMA2000 system voice frame is one frame per 20 ms). It can be considered that being within n % is a reasonable range, wherein, the value of n can be defined in accordance with communications industry standards YD/T1071-2000 “technical requirements for IP telephony gateway” standards. If n is equal to 0, the voice transmission is good; if n is equal to 1, the voice transmission is general; if n is equal to 5, the voice transmission is bad; and if n is equal to 10, the voice transmission is very bad, and the frames can not be received. In addition, the data for any two stages can be compared and a corresponding reasonable range can be set, for example, it can be considered that there should be no frame dropping between the service data unit (SDU) board and the voice transcoder (VTC) board and only the difference between them equal to 0 is reasonable, and so on.

The master control module informs each data transmitting/receiving statistics module to stop the statistics on the data transmitting/receiving.

Of course, the present device not only can be used to locate the voice transmission problems such as getting through in one-way, discontinuous, etc. occurring during a single call, but also can be used to monitor all the calls of the BSC to discover actively the voice transmission problems such as getting through in one-way, discontinuous, etc. existing in the system.

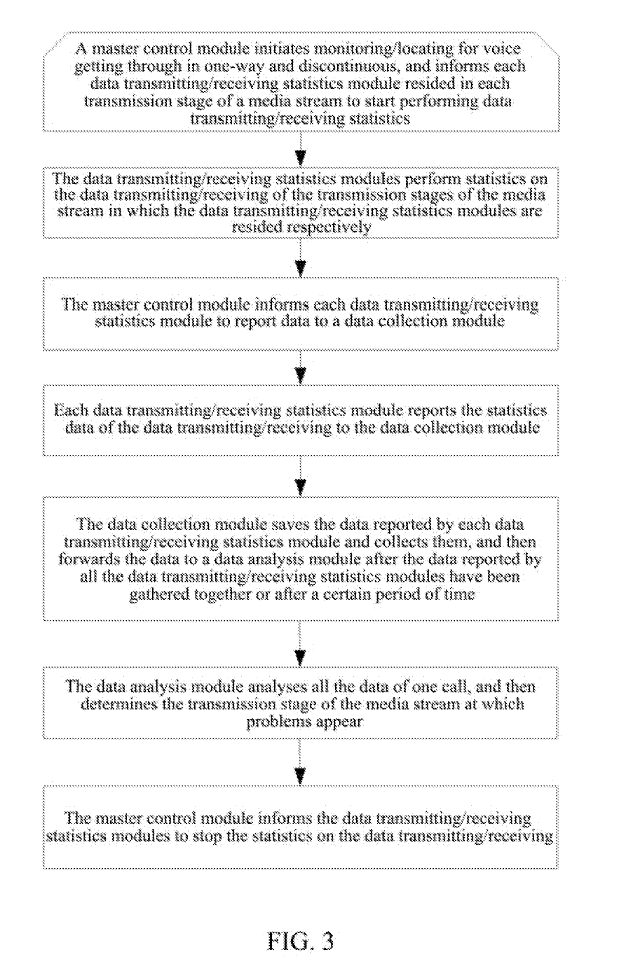

FIG. 3 illustrates a flowchart of a method for locating voice transmission problems in accordance with an embodiment of the present invention.

The specific steps of the method are as follows:

a master control is performed by a call control module of the BSC; after parameters of data transmitting/receiving statistics are set at an OMC back stage, the OMC back stage informs the call control module of the BSC; and after the call control module of the BSC fulfills a establishment process of a control stream, the call control module of the BSC informs data transmitting/receiving statistics modules resided in processing stages of a media stream, such as a CHM of the BSS, an interface board at the BTS side, an interface board at the BSC side, a SDM and a vocoder, etc., to perform the data transmitting/receiving statistics;

the data transmitting/receiving statistics modules perform statistics on the data transmitting/receiving of the transmission stages of the media stream in which the data transmitting/receiving statistics modules are resided respectively;

when a call is released, the call control module of the BSC informs each data transmitting/receiving statistics module to report data to the call control module of the BSC;

the data transmitting/receiving statistics module reports the statistics data of the data transmitting/receiving to the call control module of the BSC;

the call control module of the BSC saves the data reported by each data transmitting/receiving statistics module and collects them, sets a timer, and forwards the data to a data analysis module of the OMC back stage after the data reported by all the data transmitting/receiving statistics modules have been gathered together or after the timer is overtime;

the data analysis module analyzes all the data of one call and determines the transmission stage of the media stream at which problems appear;

the call control module of the BSC informs each data transmitting/receiving statistics module to stop the statistics on the data transmitting/receiving.

The data analysis module informs the OMC back stage of a analysis result, and the OMC back stage saves the analysis result and displays the result on an interface.

Those skilled in the art can understand that all or partial steps in the above described method can be implemented by programs instructing the related hardware. The programs can be stored in a computer readable storage medium, such as a read-only memory, a magnetic disk, or an optical disk, etc. Alternatively, all or partial steps in the above described embodiments can be implemented with one or more integrated circuits. Accordingly, each module/unit in the above described embodiments can be implemented in the form of hardware, and can also be implemented in the form of software functional module. The present invention is not limited to any specific form of the combination of the hardware and software.

The above description is only the preferred embodiments of the present invention and is not intended to limit the present invention. For those skilled in the art, the invention can have various modifications and variations. Any of modification, equivalent and improvement etc., which is made within the spirit and principle of the present invention, should be contained within the protection scope of the present invention.

### INDUSTRIAL APPLICABILITY

The present invention can automatically detect the voice transmission problems such as getting through in one-way, discontinuous, etc. in the system, and discover the voice transmission problems existing in the system in time, thereby quickly locating the transmission stage of the media stream at which the voice transmission problems appear, enhancing the location efficiency of the voice transmission problems, and shortening the fault location period.

What we claim is:

1. A device for locating voice transmission problems, comprising:
a data transmitting/receiving statistics module, configured to report data to a data analysis module after performing statistics on data transmitting/receiving of a transmission stage of a media stream, and
the data analysis module, configured to locate the voice transmission problems after analyzing the data reported by the data transmitting/receiving statistics module.

2. The device of claim 1, wherein the data analysis module comprises:
a master control module, configured to inform the data transmitting/receiving statistics module to perform or stop the statistics on the data transmitting/receiving and to start or stop reporting;
a data collection module, configured to collect and save the data reported by each data transmitting/receiving statistics modules, and forward the data to the data analysis module after the data reported by all the data transmitting/receiving statistics modules have been gathered together or after a certain period of time; and
a display module, configured to display a analysis result of the data analysis module.

3. The device of claim 2, wherein, the certain period of time is preset according to a condition of each transmission stage of the media stream.

4. The device of claim 1, wherein, the data transmitting/receiving statistics module(s) is located at one or more media plane processing nodes.

5. The device of claim 4, wherein, the media plane processing nodes comprise a channel processing module at a base station transceiver side, a selected distribute multiplex demultiplex module at a base station controller side, an interface board and a voice transcoder board.

6. The device of claim 1, wherein, the data transmitting/receiving statistics module is further configured to perform statistics on types of received frames.

7. The device of claim 1, further comprising a plurality of data analysis modules, which are located on the same board or resided in different boards.

8. The device of claim 1, wherein, the data analysis module is configured to locate the voice transmission problems according to following steps: locating the voice transmission problems by comparing statistics values of the data transmitting/receiving of each transmission stage of the media stream.

9. A method for locating voice transmission problems, comprising following steps:
configuring a data transmitting/receiving statistics module at each transmission stage of a media stream to perform statistics on data transmitting/receiving of the transmission stage;
the data transmitting/receiving statistics module reporting data after statistics to a preset data analysis module; and
the data analysis module locating the voice transmission problems after analyzing the data-reported by the data transmitting/receiving statistics module.

10. The method of claim 9, wherein, the step of the data transmitting/receiving statistics module performing the statistics on the data transmitting/receiving of each processing stage of the media stream further comprises: performing statistics on the number of transmitted and received frames.

11. The method of claim 9, wherein, the step of the data analysis module locating the voice transmission problems comprises: the data analysis module deriving a difference between the number of the received frames and the number of the transmitted frames of two transmission stages of the media stream which are adjacent or nonadjacent, and judging whether the difference is within a predetermined range; and if the difference is within the predetermined range, a voice transmission is normal, and if the difference is beyond the predetermined range, there is a problem in the voice transmission.

12. The device of claim 4, wherein, the data transmitting/receiving statistics module is further configured to perform statistics on types of received frames.

13. The method of claim 10, wherein, the step of the data analysis module locating the voice transmission problems comprises: the data analysis module deriving a difference between the number of the received frames and the number of the transmitted frames of two transmission stages of the media stream which are adjacent or nonadjacent, and judging whether the difference is within a predetermined range; and if the difference is within the predetermined range, a voice transmission is normal, and if the difference is beyond the predetermined range, there is a problem in the voice transmission.
